(19) United States
(12) Patent Application Publication
(10) Pub. No.: US 2004/0002877 A1
(43) Pub. Date: Jan. 1, 2004

(54) Method and apparatus for using a MAC address as a unique machine parameter to identify equipment

(76) Inventors: Michael F. Angelo, Houston, TX (US); E. David Neufeld, Magnolia, TX (US)

Correspondence Address: Michael G. Fletcher, Fletcher, Yoder & Van Someren, P.O. Box 692289, Houston, TX, 77269-2289, US

(21) Appl. No.: 10/184,146

(22) Filed: Jun. 28, 2002

(51) Int. Cl. G06F 17/60

(52) U.S. Cl. 705/7; 705/10

(57) ABSTRACT

The disclosed embodiments relate to verifying whether equipment is within a promised warranty period before warranty service is performed on the equipment. In one embodiment, the MAC address of a computer system is used to verify whether the computer system is covered by a promised warranty.

### BACKGROUND OF THE INVENTION

1. Field of the Invention

This invention relates generally to conserving resources by allowing companies to accurately determine whether a piece of equipment is covered by a manufacturer's warranty prior to performing warranty services on the piece of equipment. More particularly, the invention relates to using a unique piece of data associated with a piece of equipment to accurately identify whether that equipment is covered by a manufacturer's warranty.

2. Background of the Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Since the introduction of the first personal computer (“PC”) over 20 years ago, technological advances to make PCs more useful have continued at an amazing rate. Microprocessors that control PCs have become faster and faster, with operational speeds eclipsing the gigahertz (one billion operations per second) and continuing well beyond.

Productivity has also increased tremendously because of the explosion in development of software applications. In the early days of the PC, people who could write their own programs were practically the only ones who could make productive use of their computers. Today, there are thousands and thousands of software applications ranging from games to word processors and from voice recognition to web browsers.

In addition to improvements in PC hardware and software generally, the technology for making computers more useful by allowing users to connect PCs together and share resources between them has also seen rapid growth in recent years. This technology is generally referred to as “networking.” In a networked computing environment, PCs belonging to many users are connected together so that they may communicate with each other. In this way, users can share access to each other's files and other resources, such as printers. Networked computing also allows users to share internet connections, resulting in significant cost savings. Networked computing has revolutionized the way in which business is conducted across the world.

Not surprisingly, the evolution of networked computing has presented technologists with some challenging obstacles along the way. One obstacle is connecting computers that use different operating systems (“OSes”) and making them communicate efficiently with each other. Each different OS (or even variations of the same OS from the same company) has its own idiosyncrasies of operation and configuration. The interconnection of computers running different OSes presents significant ongoing issues that make day-to-day management of a computer network challenging.

Another significant challenge presented by the evolution of computer networking is the sheer scope of modern computer networks. At one end of the spectrum, a small business or home network may include a few client computers connected to a common server, which may provide a shared printer and/or a shared internet connection. On the other end of the spectrum, a global company's network environment may require interconnection of hundreds or even thousands of computers across large buildings, a campus environment or even between groups of computers in different cities and countries. Such a configuration would typically include a large number of servers, each connected to numerous client computers.

Further, the arrangements of servers and clients in a larger network environment could be connected in any of an infinite number of topologies that may include local area networks (“LANs”), wide area networks (“WANs”) and municipal area networks (“MANs”). In these larger networks, a problem with any one server computer (for example, a failed hard drive, failed network interface card or OS lock-up to name just a few) has the potential to interrupt the work of a large number of workers who depend on network resources to get their jobs done efficiently. Needless to say, companies devote a lot of time and effort to keeping their networks operating trouble-free to maximize productivity.

Like many products, most computer equipment typically comes with a manufacturer's warranty under which the manufacturer agrees to repair or replace the computer equipment within a certain amount of time following its purchase. The warranty may be limited to a specific time period. Typical warranty periods are, for example, 90 days, six months or one year. Warranties may be limited in other ways as well. For example, a warranty may only apply to a piece of equipment if the piece of equipment has remained in its original configuration without additions or other modifications, such as component substitutions.

As computers have grown in importance in modem business, sales of computer equipment has also grown over the past several years. This increased sales volume has lead to a corresponding increase in the cost associated with warranty repairs and replacements. The cost of warranty repairs and replacements are a significant burden on the manufacturers of computer equipment and those costs must eventually be passed on to other purchasers. To help contain the cost of their products, computer manufacturers desire to minimize costs associated with performing warranty repair or replacement on equipment that they sell. One obvious way to reduce warranty costs is to reduce or eliminate performing warranty repairs on equipment that is in fact not covered by the promised warranty for whatever reason.

Computer manufacturers have tried several methods of ensuring that they only perform warranty repairs or replacement of products that are still under their promised warranty period. One such method is to assign a unique serial number to each computer that is sold. A purchaser of a computer may be required to register the serial number of his/her computer with the manufacturer to qualify for warranty service. The manufacturer of the computer may require the user to identify the serial number of his computer as a condition obtaining warranty service on the computer. Upon obtaining the serial number from the user, the manufacturer may use its database of registered serial numbers to determine whether the computer for which the user seeks warranty service is within the warranty period promised upon the sale of the computer. If the computer is outside the warranty period, the manufacturer avoids the costs associated with repairing or replacing the unit.

A problem with using serial numbers to determine whether products are under warranty is that it is difficult to permanently mark a computer with a serial number. For example, it has not proven practical to permanently inscribe a serial number on the chassis of each computer as it is manufactured. As an alternative, some manufacturers have tried placing the serial number on a label that is affixed to each computer as it is manufactured. If the serial number, however, is affixed by a label, the label of a newer machine that is under warranty may be substituted for the label of an older machine that has broken but is no longer under warranty. In this manner, the computer manufacturer may expand resources repairing or replacing equipment that is no longer within its promised warranty period.

Another method of providing a serial number with each computer is to store the serial number in a non-volatile memory location within the computer. A knowledgeable user of the computer may, however, have the ability to overwrite the memory location containing the serial number. In this manner, the user could substitute a serial number from a machine that is under warranty for the serial number of a broken machine that is no longer under warranty.

A way to accurately identify computer equipment that is genuinely under a manufacturer's warranty prior to performing warranty repairs or replacement is desirable.

### BRIEF DESCRIPTION OF THE DRAWINGS

The foregoing and other advantages of the invention will become apparent upon reading the following detailed description and upon reference to the drawings in which:

FIG. 1 is a block diagram illustrating a computer system in which the present invention may be practiced;

FIG. 2 is a block diagram of a motherboard that may incorporate components shown in FIG. 1; and

FIG. 3 is a flow diagram that is useful in explaining the present invention.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

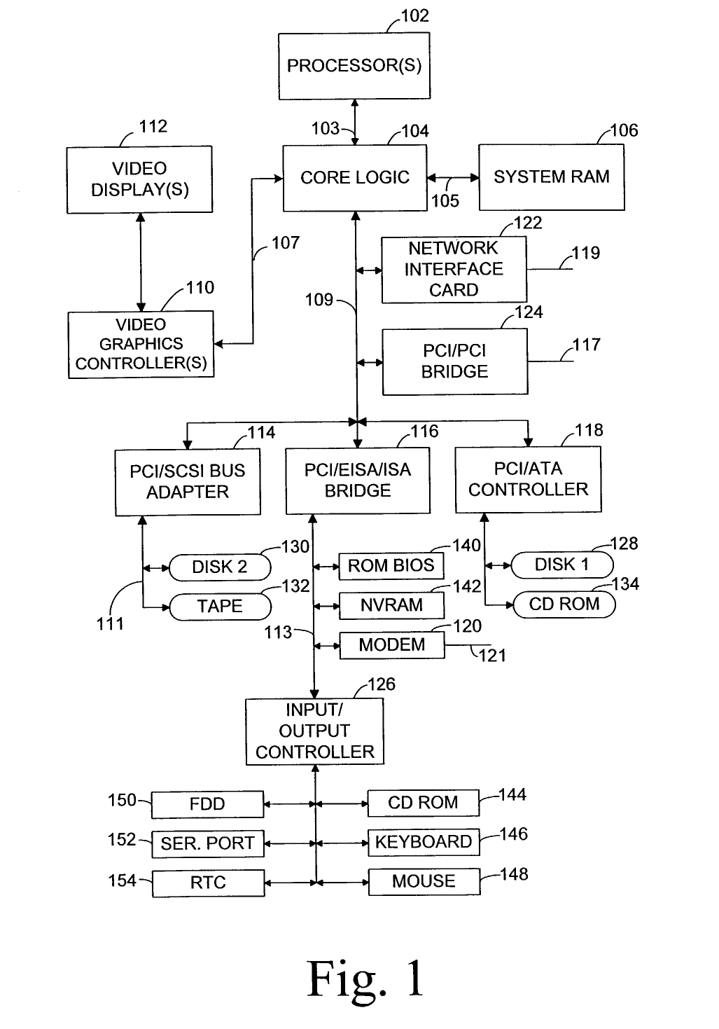

Referring now to FIG. 1, a schematic block diagram of a computer system utilizing the present invention is illustrated. A computer system is generally indicated by the numeral 100 and comprises a processor (or processor complex comprising multiple central processing units) 102. Also included in the computer system 100 are core logic 104 (or north bridge), system random access memory (“RAM”) 106, a video graphics controller(s) 110, a video display(s) 112, a PCI/SCSI bus adapter 114, a PCI/EISA/ISA bridge 116, and a PCI/ATA controller 118. A hard drive 128 and CD ROM drive 134 may be connected to the PCI/ATA controller 118.

Single or multilevel cache memory (not illustrated) may also be included in the computer system 100 according to the current art of microprocessor computer systems. If the computer system 100 includes multiple processors, they may be arranged in a symmetric or asymmetric multi-processor configuration.

The processor 102 is connected to the core logic 104 through a host bus 103. The system RAM 106 is connected to the core logic 104 through a memory bus 105. The configuration registers of the computer system may be incorporated into the processor or in the system RAM 106 (or some combination of the two). The configuration registers may be designed to control the operation of many of the system components shown in FIG. 1.

The video graphics controller(s) 110 is connected to the core logic 104 through an AGP bus 107 (or other bus for transporting video data). The PCI/SCSI bus adapter 114, PCI/EISA/ISA bridge 116, and PCI/ATA controller 118 are connected to the core logic 104 through a primary PCI bus 109. Those of ordinary skill in the art will appreciate that a PCI-X bus or Infiniband bus may be substituted for the primary PCI bus 109. The specific protocol of the bus 109 is not a crucial aspect of the present invention.

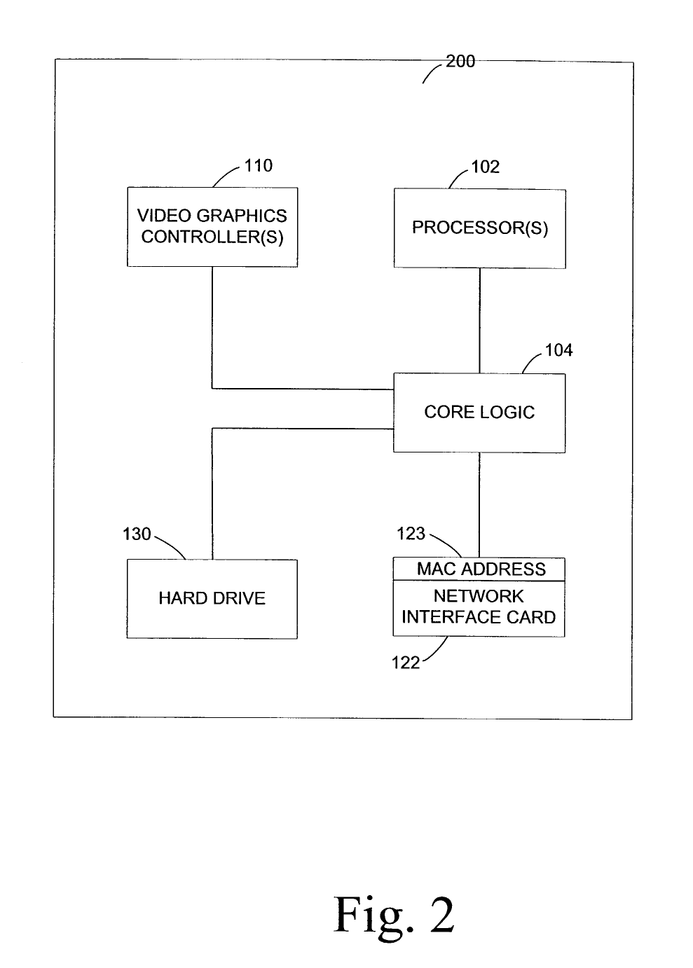

Also connected to the PCI bus 109 are a network interface card (“NIC”) 122 and a PCI/PCI bridge 124. Some of the PCI devices such as the NIC 122 and PCI/PCI bridge 124 may be embedded on a motherboard (FIG. 2) or may plug into PCI connectors on the motherboard. The PCI/PCI bridge 124 provides an additional PCI bus 117.

Hard disk 130 and tape drive 132 are connected to the PCI/SCSI bus adapter 114 through a SCSI bus 111. The NIC 122 is connected to a local area network 119. The PCI/EISA/ISA bridge 116 connects over an EISA/ISA bus 113 to a non-volatile random access memory (NVRAM) 142, modem 120, and input-output controller 126. The NVRAM 142 may store the system BIOS and/or other programming and may include flash memory, as discussed below with respect to FIG. 2. Additionally, the NVRAM may be contained in a programmable logic array (“PAL”) or any other type of programmable non-volatile storage. The modem 120 connects to a telephone line 121. The input-output controller 126 interfaces with a keyboard 146, CD-ROM drive 144, mouse 148, floppy disk drive (“FDD”) 150, serial/parallel ports 152 and a real time clock (“RTC”) 154. The EISA/ISA bus 113 is a slower information bus than the PCI bus 109, but it costs less to interface with the EISA/ISA bus 113.

FIG. 2 is a block diagram of a motherboard 200 that may incorporate some of the components shown in FIG. 1. The motherboard 200 is adapted to receive the processor 102. Additionally, the motherboard 200 may incorporate the core logic chipset 104 and the NIC 122, either or both of which may be “embedded,” or permanently incorporated therein.

The NIC 122 is typically assigned an identifying number known as the media access control address (or “MAC address”) 123. The MAC address 123 is used to uniquely identify the NIC 122 in a networked computing environment. MAC addresses are administered by the Institute of Electrical and Electronics Engineers (“IEEE”), which is a standards-setting body in the electronics industry. A MAC address typically consists of two parts. The first part of the MAC address 123 is typically a manufacturer code that is assigned by the IEEE to the manufacturer of the NIC 122. The manufacturer typically uses the manufacturer code as the first part of the MAC address of all NICs that it manufacturers. The second part of the MAC address 123 is sometimes known as a board ID or extension ID and is typically a unique number assigned to each NIC. The MAC address 123 is typically stored in a read-only memory (“ROM”) portion of the NIC 122, which may not be changed. Accordingly, the MAC address 123 is typically an unchangeable, unique identifier of a NIC. Even in cases where the MAC address is programmable (changeable), the operation of other system devices may be tied to a unique MAC address, making cloning of the MAC address difficult from a practical standpoint. In other words, the system may be configured so that certain devices only work with a specific MAC address.

All computers in a given network must have unique MAC addresses or the likely result is that neither will function correctly on the network. This is true because each computer on a network must have a unique MAC address to correctly receive data addressed to it. If two computers on the same network have the same MAC address, the result would be similar to a situation in which two houses in the same city have the same street address. In that situation, it would be impossible to ensure that mail addressed to a specific one of the two houses having the same address would reach the correct destination. Similarly, in a computer network it would be impossible to assume that two computers with the same MAC address were each receiving the correct data. Because of this concern, manufacturers of NICs typically assign unique MAC addresses to all of NICs manufactured by them in the event that two of their NICs are used in the same network.

Some computer systems have more than one NIC and, accordingly, more than one MAC address. For example, server computers may include a remote server management board that includes a separate NIC for server management communications. In the case of a computer system that has more than one MAC address, either MAC address may be used to implement the present invention. Additionally, portions of the multiple MAC addresses may be used to create a unique code. The multiple MAC addresses or portions thereof may additionally be combined, hashed or encrypted and the resulting code used as a unique identifier for purposes of implementing the present invention.

The status of the MAC address of a NIC as a unique and practically unchangeable identifier makes it ideal to use as a verification tool for warranty service. For example, a manufacturer of computer equipment may require a customer to register the MAC address of all computers purchased by the customer. The manufacturer may require the customer to provide the MAC address for any unit requiring warranty service. Warranty service may be denied if the registration data maintained by the manufacturer indicates that the computer system corresponding to a specific MAC address is no longer within the promised warranty period.

Additionally, the MAC address (or a portion thereof) may be used in connection with other registration data to verify whether a specific computer system is covered by a promised warranty. For example, unique identifiers may be created by combining or concatenating the MAC address with serial numbers or other identifying data from additional components within a given computer system. Examples of other components that may have serial numbers or other identifiers are the system microprocessor 102, core logic chipset 104, hard drive 130 or video graphics controller 110. In addition to data from other system components, the MAC address may be combined or concatenated with other data that would be useful in identifying a specific computer system. Examples of such data include a system configuration identifier, a warranty time period, a system ship date and the like.

In addition to being used as a unique identifier, the MAC address 123 may be used as a key to encrypt serial numbers or other identifiers associated with a given computer. The computer system manufacturer could require the customer to provide this encrypted identifier as a condition of providing warranty service. The computer system manufacturer may decrypt the data to determine if the identifying data corresponds to a computer system that is within a promised warranty period.

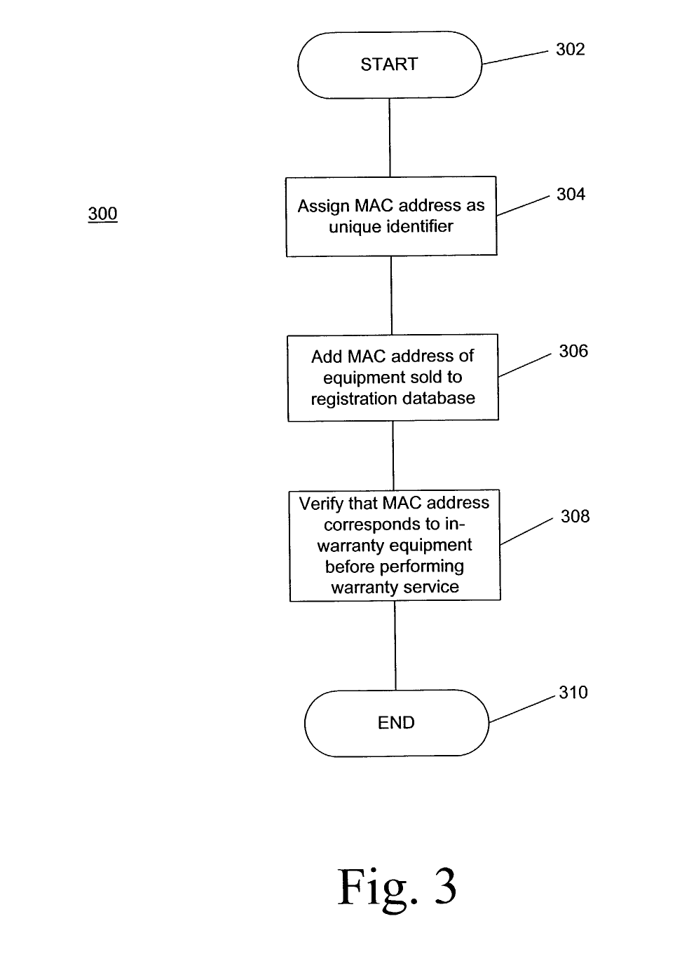

FIG. 3 is a flow diagram that is useful in explaining the present invention. The process is generally referred to by the reference numeral 300. At 302 the process is initiated and at 304 a MAC address (or portion thereof) is assigned as a unique identifier for a piece of equipment. The MAC address is entered into a registration database at 306. The registration database is typically created when purchasers of products register the product to be eligible for warranty service.

Instead of using just the MAC address, a portion of the MAC address may be used as the identifier. Alternatively, the MAC address or portion thereof may be combined, hashed, or concatenated with other data or used as an encryption key to form an identifier.

At 306, the registration data base containing the MAC address of a given system is used in response to a request for warranty service to verify whether the system in question is still covered by the promised warranty. If not, warranty service for the equipment may be denied. The process terminates at 310.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A system for determining if a piece of equipment is covered by a warranty, the system comprising:
a registration database adapted to store registration information identifying the piece of equipment;
at least a portion of a MAC address corresponding to the piece of equipment, the at least a portion of the MAC address being adapted to create an identifier to be stored in the registration database as part of the registration information; and
whereby the registration database may be accessed responsive to a request for warranty services on the piece of equipment and the identifier used to determine whether the piece of equipment is covered by a promised warranty.

2. The system of claim 1 wherein the entire MAC address is adapted to be used to create the identifier.

3. The system of claim 1 wherein the entire MAC address is used as the identifier.

4. The system of claim 1 wherein the at least a portion of the MAC address is used in conjunction with other configuration information to form the identifier.

5. The system of claim 4 wherein the other configuration information comprises a serial number from at least one component of the piece of equipment.

6. The method of claim 4 wherein the other configuration information comprises a serial number from the piece of equipment.

7. The system of claim 1 wherein the at least a portion of the MAC address is used as an encryption key to form the identifier.

8. The system of claim 1 wherein the piece of equipment is a computer.

9. A method of verifying whether a piece of equipment is covered by a promised warranty, the piece of equipment having a MAC address, the method comprising the acts of:
using at least a portion of the MAC address to create an identifier for the piece of equipment;
storing the identifier in a registration database; and
responding to a request for warranty services on the piece of equipment by accessing the registration database and using the identifier to determine if the piece of equipment is covered by a promised warranty.

10. The method of claim 9, comprising the act of performing warranty service on the piece of equipment if the identifier indicates that the piece of equipment is covered by the promised warranty.

11. The method of claim 9 wherein the entire MAC address is used to create the identifier.

12. The method of claim 9 wherein the entire MAC address is used as the identifier.

13. The method of claim 9 wherein the at least a portion of the MAC address is used in conjunction with other configuration information to form the identifier.

14. The method of claim 13 wherein the other configuration information comprises a serial number from at least one component of the piece of equipment.

15. The method of claim 13 wherein the other configuration information comprises a serial number from the piece of equipment.

16. The method of claim 7 further comprising the act of using at least a portion of the MAC address as an encryption key to form the identifier.

17. A registration database, comprising:
a plurality of identifier entries, each of the identifier entries comprising at least a portion of a MAC address, the at least a portion of the MAC address corresponding to a piece of equipment;
a plurality of configuration entries, each of the configuration entries associated with one of the plurality of identifier entries; and
whereby the registration database may be accessed responsive to a request for warranty services on the piece of equipment and a corresponding identifier entry and configuration entry used to determine whether the piece of equipment is covered by a promised warranty.

18. The registration database of claim 17 wherein the entire MAC address is used to create the identifier entry.

19. The registration database of claim 17 wherein the at least a portion of the MAC address is used in conjunction with other configuration information to form the identifier entry.

20. The registration database of claim 17 wherein the piece of equipment is a computer system.
